(19) United States
(12) Patent Application Publication
(10) Pub. No.: US 2011/0041672 A1
(43) Pub. Date: Feb. 24, 2011

(54) METHOD AND SYSTEM FOR MIDI CONTROL OVER POWERLINE COMMUNICATIONS

(75) Inventors: Tat Keung CHAN, South San Francisco, CA (US); Elsa A. Chan, South San Francisco, CA (US); Joshua L. Fix, Larchmont, NY (US)

Correspondence Address: AMPACC Law Group, PLLC, 6100 219th Street SW, Suite 580, Mountlake Terrace, WA, 98043, US

(73) Assignee: Jetlun Corporation, South San Francisco, CA (US)

(21) Appl. No.: 12/858,370

(22) Filed: Aug. 17, 2010

Related U.S. Application Data
(60) Provisional application No. 61/234,765, filed on Aug. 18, 2009.

(51) Int. Cl. G10H 7/00

(52) U.S. Cl. 84/645

(57) ABSTRACT

An apparatus for processing one or more MIDI signals into a powerline format. The apparatus has an input port configured to receive a first digital signal having a MIDI format. The apparatus also has one or more powerline modules configured to process at least the digital signal in the MIDI format to a second digital signal in a powerline format. The apparatus also has an output port configured to transfer the second digital signal.

### CROSS-REFERENCES TO RELATED APPLICATIONS

Not applicable

### STATEMENT AS TO RIGHTS TO INVENTIONS MADE UNDER FEDERALLY SPONSORED RESEARCH AND DEVELOPMENT

Not applicable

### REFERENCE TO A “SEQUENCE LISTING,” A TABLE, OR A COMPUTER PROGRAM LISTING APPENDIX SUBMITTED ON A COMPACT DISK

Not applicable

### BACKGROUND OF THE INVENTION

The present invention relates generally to musical techniques. More particularly, the present invention provides a method and system for networking musical instruments and the like. But it would be recognized that the invention can have a much broader range of application.

MIDI (Musical Instrument Digital Interface, IPA:/′mIdi/) is an industry-standard protocol that enables electronic musical instruments, computers, and other equipment to communicate, control, and synchronize with each other. MIDI allows computers, synthesizers, MIDI controllers, sound cards, samplers and drum machines to control one another, and to exchange system data (acting as a raw data encapsulation method for sysex commands).

As an electronic protocol, it is notable for its widespread adoption throughout the industry, and for continuing in use since its introduction in 1983. Today, most popular recorded music is written and performed using MIDI-equipped electronic keyboards (aka “synthesizers”). Much music is also written on computers using “Sequencers” and/or “Digital Audio workstations”. Other MIDI-equipped musical instruments may also be used, including digital drums, digital guitars, wind instruments, and more.

Most computers have the ability to play MIDI files using either built-in hardware or a software synthesizer that responds to MIDI messages, and with an appropriate adapter your computer can be connected to other MIDI-equipped products so you can use MIDI to help you learn, play, create and enjoy music.

Even film and TV scores are usually created on MIDI instruments, and with advances in digital sampling and synthesis technologies making digital instruments sound ever more realistic, the orchestra playing behind that big-screen block buster is more likely to be the product of a few MIDI devices than dozens of acoustic instruments.

Whereas producing music and sound-design in the past relied more heavily on acoustic instruments and ensembles—with a minimum of required electronic connections in the studio—the proliferation of MIDI and computers in the production process requires more and more direct connections to transfer data signals. More connections typically means more cabling.

MIDI, however, has limitations. That is, MIDI does not transmit an audio signal or media—it transmits “event messages” such as the pitch and intensity of musical notes to play, control signals for parameters such as volume, vibrato and panning, cues, and clock signals to set the tempo. A common problem in commercial, professional, semi-professional project studios and home studios alike is the overwhelming clutter associated with connection cables, especially when some devices need to be situated any type or distance from their signal destination (or receiver) for convenience, logistics and general space management purposes.

These cables include various audio cables, electrical power cables, and cables used for connecting MIDI (musical instrument digital interface) controllers and instruments to sound modules and/or computers. Certain controllers, such as MIDI drumkits, or MIDI-equipped grand pianos, are extremely large and unwieldy, and do not have portability, which limits organizational options greatly.

From the above, it is seen that techniques for improving MIDI and use of musical instruments are highly desirable.

### BRIEF SUMMARY OF THE INVENTION

According to the present invention, techniques related generally to musical are provided. More particularly, the present invention provides a method and system for networking musical instruments and the like. But it would be recognized that the invention can have a much broader range of application.

In a specific embodiment, the present invention provides a system and method that offers a more streamlined and convenient environment to make using electronic music hardware and software easier. Of course, there can be other variations, modifications, and alternatives.

In a specific embodiment, the invention provides a system including at least two receiver/transmitter modules that carry MIDI data signals (or any future derivation or improvement on current MIDI signal protocols, such as OSC, mLAN, or HMIDI etc.) between a MIDI controller and a MIDI receiver over existing electrical powerlines. In one or more embodiments, the system is intended for use over a local area of [x distance. Sq. meters] and generally requires that the two power connections are on the same transformer or other variations.

The invention present invention provides a module can be used with any device that transmits MIDI signals (or any future derivation or improvement on current MIDI signal protocols, such as OSC, mLAN, or HMIDI etc.) according to other embodiments. As stated previously, a common problem in all studios alike is the overwhelming clutter associated with connection cables, especially when some devices need to be situated any distance from their signal destination (or receiver.) Of course, there can be other variations, modifications, and alternatives.

In yet an alternative embodiment, the present invention provides an apparatus for processing one or more MIDI signals into a powerline format. The apparatus has an input port configured to receive a first digital signal having a MIDI format. The apparatus also has one or more powerline modules configured to process at least the digital signal in the MIDI format to a second digital signal in a powerline format. The apparatus also has an output port configured to transfer the second digital signal. As used herein, the term “module” is defined by ordinary meaning and can include a single or multiple modules and/or other like devices.

As an example of this method: a MIDI controller connects to Module 1 via MIDI connection or USB. Module 1 plugs into the nearest available power outlet. Module 2 is plugged into another power outlet and receives the signal over the powerline, which it sends to the MIDI receiver or computer it is connected to via MIDI or USB connection. Further details of the present invention can be found throughout the present specification and more particularly below.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a simplified diagram of the system according to an embodiment in the present invention;

FIG. 2 is a simplified block diagram of the MIDI to Powerline Adapter according to an embodiment in the present invention; and

FIG. 3 is a simplified block diagram of a MIDI to Powerline Switch according to an embodiment in the present invention.

### DETAILED DESCRIPTION OF THE INVENTION

According to the present invention, techniques related generally to musical are provided. More particularly, the present invention provides a method and system for networking musical instruments and the like. But it would be recognized that the invention can have a much broader range of application.

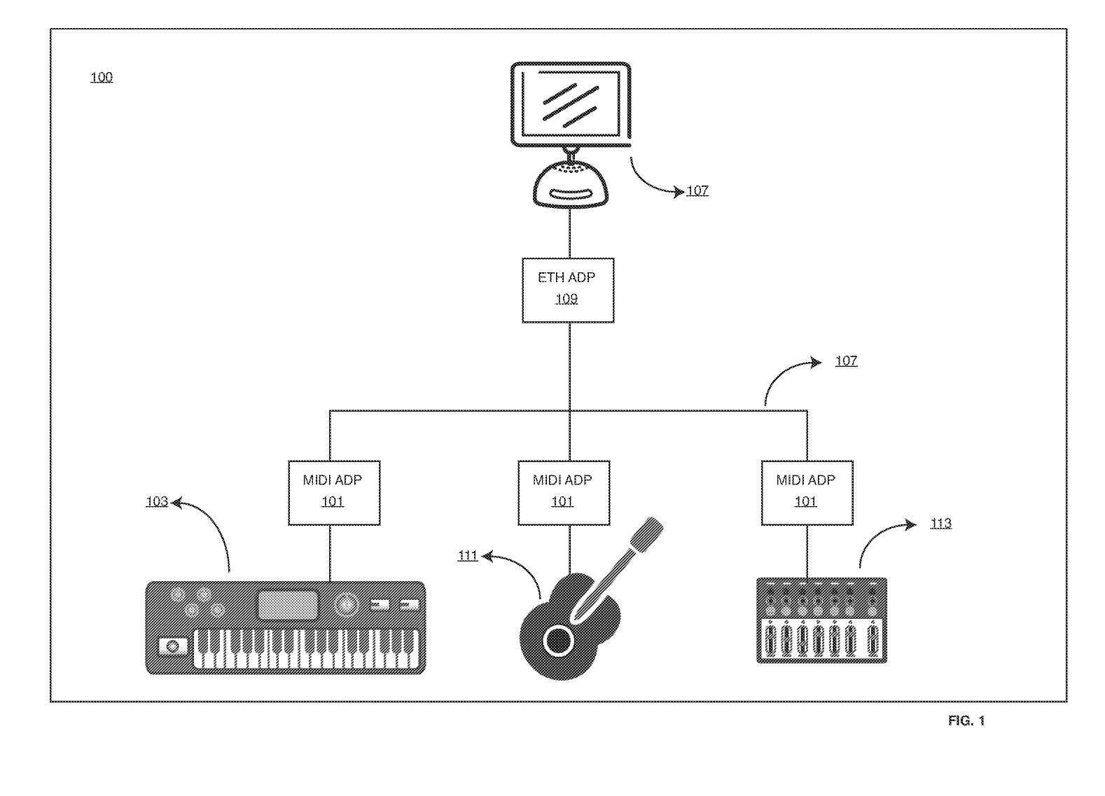

FIG. 1 is a simplified diagram of the system 100 according to an embodiment in the present invention. This diagram is merely an example, which should not unduly limit the scope of the claims herein. One of the ordinary skills in the art would recognize many variations, alternatives, and modifications. As shown, a MIDI to Powerline Adapter 101 is connected to a keyboard 103. Musical notes played from the keyboard 103 is transmitted through the MIDI to Powerline Adapter 101 over the AC wiring 105 to a computer 107 that is connected to a Powerline Ethernet Adapter 109. The system can be scaled by adding additional MIDI Powerline Adapters 101 and connect them to other musical devices such as electric guitar 111 and a midi controller 113.

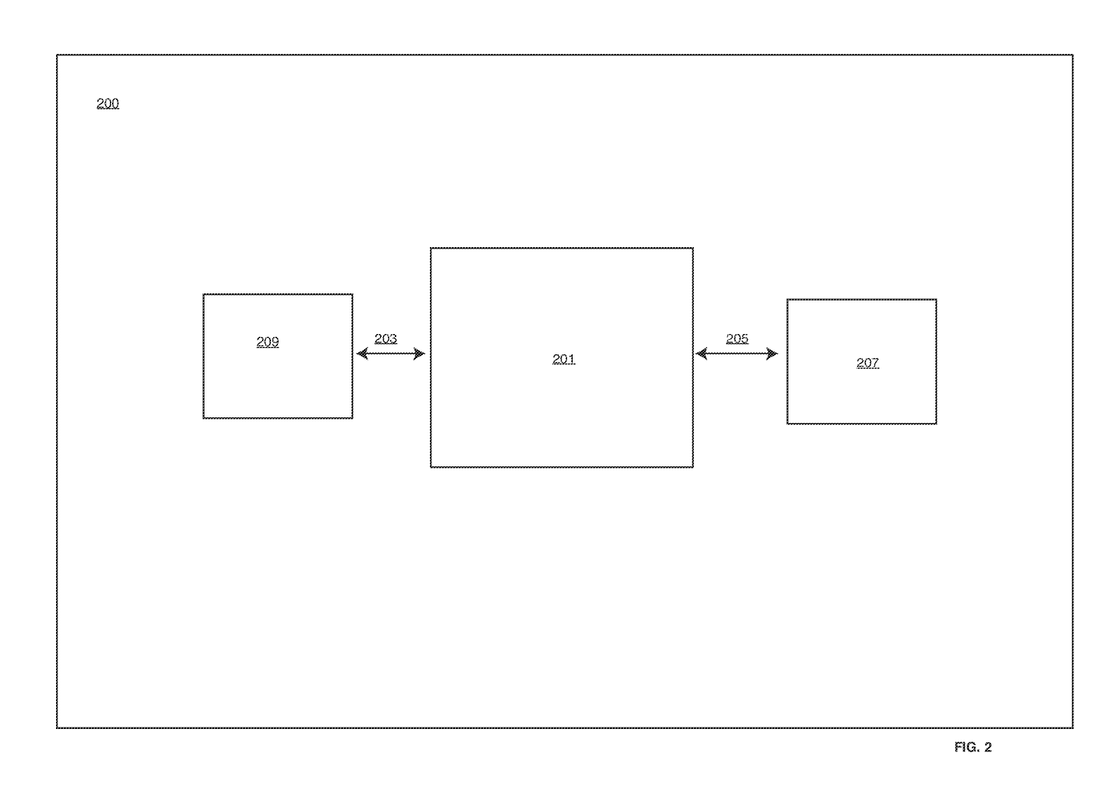

FIG. 2 is a block diagram of the MIDI to Powerline Adapter according to an embodiment in the present invention. This diagram is merely an example, which should not unduly limit the scope of the claims herein. One of the ordinary skills in the art would recognize many variations, alternatives, and modifications. As shown, a Central Processing Unit (CPU) 201 couples a RS232 signal 203 to a MII and/or UART interface 205. The MII Interface 205 is then connected to a Powerline module 207. The RS232 Signal 203 is couple to a MIDI connector 209.

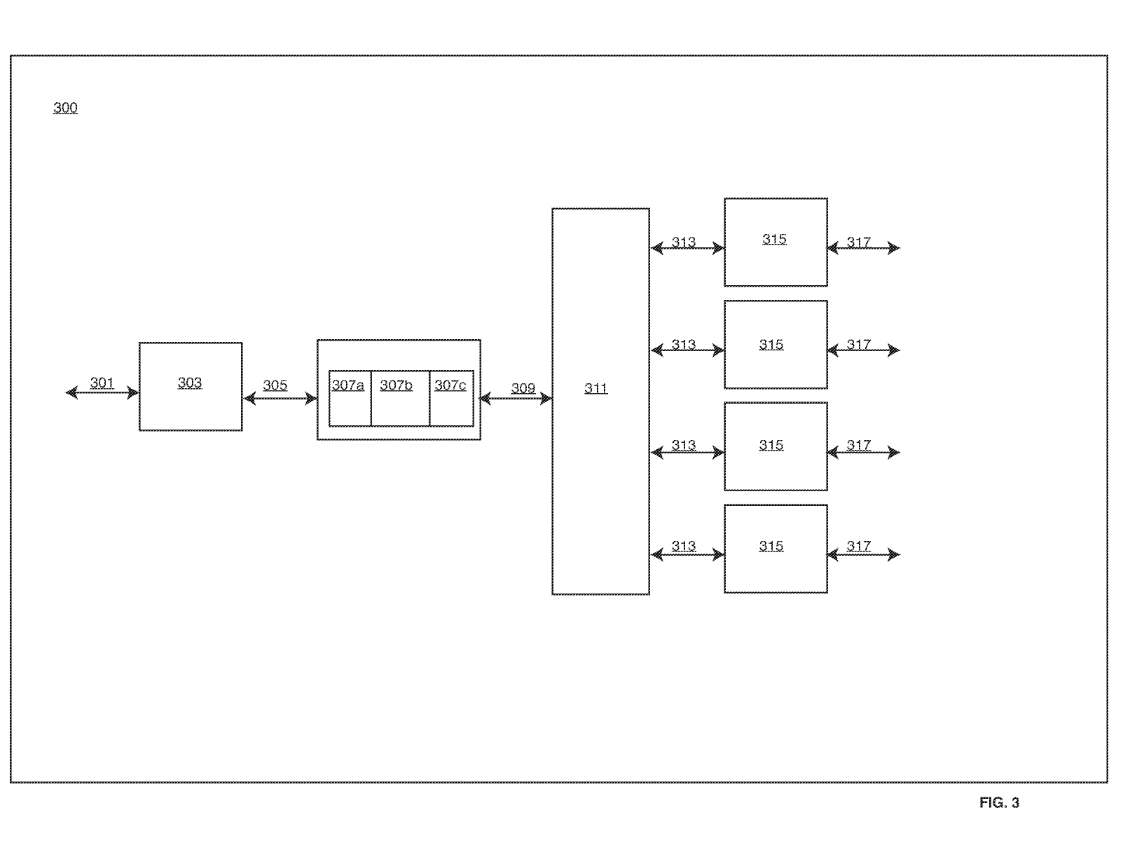

FIG. 3 is a block diagram of a MIDI to Powerline Switch according to an embodiment in the present invention. This diagram is merely an example, which should not unduly limit the scope of the claims herein. One of the ordinary skills in the art would recognize many variations, alternatives, and modifications. As shown, a powerline signal (301) is connected to a powerline module (303) and is coupled to a Central Processing Unit (CPU) 307 through a MII and/or UART interface (305). The CPU (307) has a MAC (307a), an ARM core (307b) and a USB converter (307c). The CPU is then connected to a USB Hub (311) through a USB interface (309). The USB Hub is then connected to a serial RS232 to MIDI converter (315) through a USB to serial 232 (313). The Serial RS232 to MIDI converter (315) has an input and output of MIDI (317).

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A method for processing one or more MIDI signals into a powerline format, the method comprising:
outputting a first digital signal having a MIDI format;
processing the digital signal in the MIDI format to a second digital signal in a powerline format; and
transferring the second digital signal.

2. The method of claim 1 wherein the first digital signal is derived from a keyboard, guitar, or drum set.

3. The method of claim 1 wherein the first digital signal is derived from a mixer or amplifier.

4. The method of claim 1 wherein the first digital signal is one of a plurality of digital signals.

5. The method of claim 1 wherein the powerline format is OFDM.

6. The method of claim 1 wherein the transferring is provided through one or more powerline cables.

7. The method of claim 1 wherein the transferring is provided through one or more coaxial cables.

8. The method of claim 1 wherein the transferring is provided through one or more phone cables.

9. The method of claim 1 wherein the processing is provided using one or more powerline modules.

10. The method of claim 9 wherein the one or more powerline modules comprises a powerline integrated circuit coupled to an analog front end.

11. An apparatus for processing one or more MIDI signals into a powerline format, the apparatus comprising:
an input port configured to receive a first digital signal having a MIDI format;
one or more powerline modules configured to process at least the digital signal in the MIDI format to a second digital signal in a powerline format; and
an output port configured to transfer the second digital signal.

12. The apparatus of claim 11 wherein the first digital signal is derived from a keyboard, guitar, or drum set.

13. The apparatus of claim 11 wherein the first digital signal is derived from a mixer or amplifier.

14. The apparatus of claim 11 wherein the first digital signal is one of a plurality of digital signals.

15. The apparatus of claim 11 wherein the powerline format is OMNI.

16. The apparatus of claim 11 wherein the transferring is provided through one or more powerline cables.

17. The apparatus of claim 11 wherein the transferring is provided through one or more coaxial cables.

18. The apparatus of claim 11 wherein the transferring is provided through one or more phone cables.

19. The apparatus of claim 11 wherein the processing is provided using one or more powerline modules.

20. The apparatus of claim 19 wherein the one or more powerline modules comprises a powerline integrated circuit coupled to an analog front end.
